(19) United States
(12) Patent Application Publication
(10) Pub. No.: US 2008/0198398 A1
(43) Pub. Date: Aug. 21, 2008

(54) Image forming apparatus, image forming method and computer readable medium and computer data signal for image formation

(75) Inventor: Mamoru Sasamae, Saitama-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Minato-ku (JP)

(21) Appl. No.: 11/514,234

(22) Filed: Sep. 1, 2006

(30) Foreign Application Priority Data
Feb. 28, 2006 (JP) 2006-052766

(51) Int. Cl. G06F 3/12

(52) U.S. Cl. 358/1.15

(57) ABSTRACT

An image forming apparatus is provided and includes: a storage unit that holds target data information on image data to which image formation processing is applied and processing information on a process of the image formation processing; a generating unit that generates hint information on optimization of the image forming apparatus in accordance with a presentation rule; and a display that provides the hint information.

### BACKGROUND

(i) Technical Field

This invention relates to an image forming apparatus of a multiple function processing machine, a printer, etc. The invention also relates to an image forming method, a computer readable medium for image formation and a computer data signal for image formation.

(ii) Related Art

In recent years, a multiple function processing machine and a printer have become increasingly multifunctional and various optional devices have also been provided. Under these circumstances, often the optional device selected and installed by a user and user's settings do not necessarily contribute to improvement in the work efficiency of a user.

### SUMMARY

According to one aspect of the present invention, there is provided an image forming apparatus including: a storage unit that holds target data information on image data to which image formation processing is applied and processing information on a process of the image formation processing; a generating unit that generates hint information on optimization of the image forming apparatus in accordance with a presentation rule; and a display that provides the hint information.

### BRIEF DESCRIPTION OF THE DRAWINGS

Embodiments of the present invention will be described in detail based on the following figures, wherein:

FIG. 1 is a block diagram to show a configuration of an image forming apparatus according to an exemplary embodiment of the invention;

FIG. 2 is a schematic representation to show a presentation setting screen example for each hint information group of an image forming apparatus according to an exemplary. embodiment of the invention;

FIG. 3 is a schematic representation to show a screen example for setting memory size conditions of an image forming apparatus according to an exemplary embodiment of the invention;

FIG. 4 is a schematic representation to show a retention example for presentation settings of hint information in an image forming apparatus according to an exemplary embodiment of the invention;

FIG. 5 is a schematic representation to show a record example concerning the memory size of an image forming apparatus according to an exemplary embodiment of the invention;

FIG. 6 is a schematic representation to show a record example concerning image formation modes of an image forming apparatus according to an exemplary embodiment of the invention;

FIG. 7 is a schematic representation to show a record example of settings of various functions of an image forming apparatus according to an exemplary embodiment of the invention;

FIG. 8 is a schematic representation to show a screen example for setting the execution timing of hint information presentation processing of an image forming apparatus according to an exemplary embodiment of the invention; and

FIG. 9 is a schematic representation to show a record example concerning trays of an image forming apparatus according to an exemplary embodiment of the invention.

### DETAILED DESCRIPTION

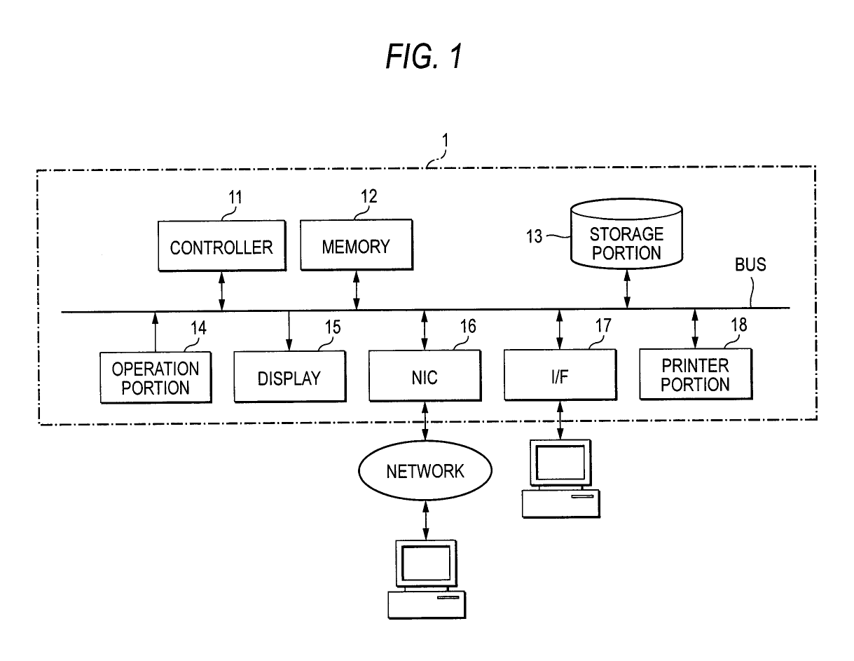

An exemplary embodiment of the invention will be discussed with reference to the accompanying drawings. An image forming apparatus 1 according to an exemplary embodiment of the invention is a printer, for example, and includes a controller 11, a memory 12, a storage portion 13, an operation portion 14, a display 15, a network interface portion (NIC) 16, an interface portion (I/F) 17, and a printer portion 18, as illustrated in FIG. 1.

The controller 11 is a program control device such as a CPU and operates in accordance with a program stored in the memory 12. The controller 11 executes processing of recording target data information concerning image data to which image formation processing is applied and processing information concerning the process of the image formation processing (record processing) and processing of generating and presenting hint information concerning optimization of the apparatus 1 based on the records (hint presentation processing). The operation of the controller 11 is described later in detail.

The memory 12 is implemented including a storage device of RAM (Random Access Memory), PROM (Programmable Read-Only Memory), etc. The memory 12 operates as a computer-readable record medium for retaining programs executed by the controller 11. The memory 12 also operates as work memory of the controller 11. In the embodiment, the controller 11 reads image data to which processing is applied into the memory 12, generates bit map data, and stores the bit map data.

The storage portion 13 is implemented using a disk device of a hard disk, etc. The storage portion 13 regains the target data information and the processing information according to a command input from the controller 11.

The operation portion 14 is implemented including a transparent touch panel put on the display 15, switches, buttons, etc. The operation portion 14 accepts command entry operation of a user and outputs the description of the command entry operation to the controller 11. The display 15 is a liquid crystal display, etc., and displays an interface screen, a message, etc, in accordance with the command input from the controller 11.

The NIC 16 is connected to a network and outputs image data received through the network from a client such as a personal computer to the controller 11. The I/F 17 is a serial interface such as a USB (Universal Serial Bus), for example, and is connected to a client such as a personal computer; it receives image data from the connected client and outputs the image data to the controller 11.

The printer portion 18 forms an image based on image data on a record medium such as paper in accordance with a command input together with image data of a bit map from the controller 11. In the embodiment, it is assumed that the printer portion 18 can print pixels in color materials of cyan, magenta, yellow, black, etc., to form a color image. The printer portion 18 is controlled in color mode or monochrome mode by the controller 11. It is assumed that in the color mode, the color materials are set up before print is started and that in the monochrome mode, only the color material of black is set up before print is started. It is assumed that to switch from the color mode to the monochrome mode or to switch from the monochrome mode to the color mode, processing of changing the color materials to be set, etc., is performed and accordingly wait time (timer period during which image formation is not performed) occurs when the color mode and the monochrome mode are switched. The printer portion 18 previously stores either mode (either of the color mode and the monochrome mode) as default; in the default mode, initially, setup processing, etc., is started and when it is necessary to change the mode based on image data, the mode is switched in accordance with the command input from the controller 11.

Next, the processing of the controller 11 according to the embodiment will be discussed. In the embodiment, conditions and propositions (hint information) are previously retained in the memory 12 or the storage portion 13 in association with each other as proposition rules involved in optimization of the apparatus 1. For example, a message for recommending addition of memory is used as hint information and a condition of the number of times memory has become insufficient, the occurrence ratio, etc., is associated with the hint information. The conditions contained in the proposition rules are preset by a user.

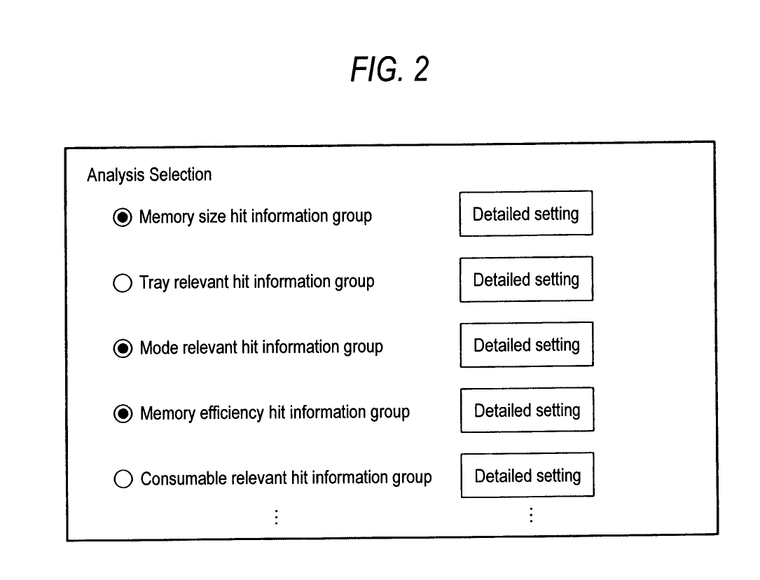

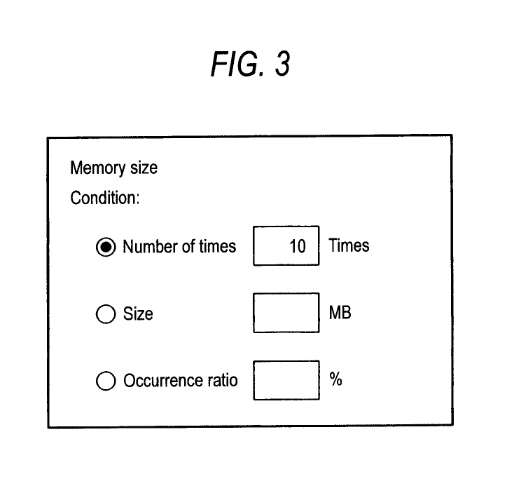

A user sets the conditions through a screen as illustrated in FIG. 2. In the embodiment, the presented hint information is previously classified into memory, paper tray, and other hint information groups and for each hint information group, presentation or no presentation of the hint information belonging to the hint information group is set. A user presses a button to execute “detailed setting” associated with each element on the screen in FIG. 2, whereby conditions of the number of times memory has become insufficient, the insufficient size, the occurrence ratio, etc., can be set as shown in FIG. 3 for memory, for example.

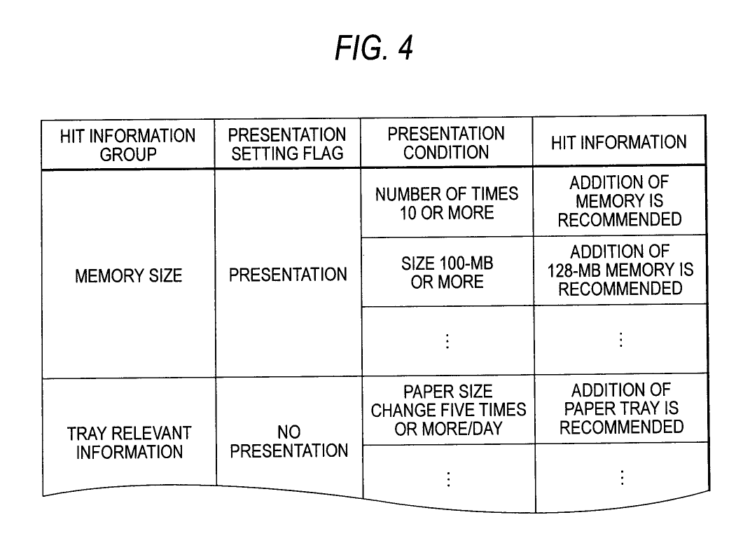

According to the settings made on the screens, the controller 11 stores a presentation setting flag indicating presentation or no presentation, at least one piece of presented hint information, the presentation condition corresponding to each piece of hint information in the memory 12 or the storage portion 13 in association with each other for each hint information group as shown in FIG. 4.

Upon reception of the image data to which image formation processing is applied through the NIC 16 or the I/F 17, the controller 11 examines which reception route (port) the image data is accepted through, and records the history in the storage portion 13. As the history, the number of times image data has been received may be counted and recorded for each port capable of receiving image data, such as the NIC 16 or the I/F 17.

The controller 11 determines the type of description language used to describe the received image data. The description language is PostScript (registered trademark) or any other PDL (page description language), for example, and the controller 11 examines which description language is used from the header part of the image data, for example, and records the history. Also as the history, the number of times image data has been received for each type of description language may be counted and recorded.

Further, the controller 11 extracts information of the paper size specified for image formation, information indicating that image data is color or monochrome, information for determining the paper tray used for image formation, information indicating whether or not image formation is to be executed on both sides, etc., from the received image data. The controller 11 stores the records concerning them in the storage portion 13. As the paper size information, the number of times paper has been specified for each piece of determined paper tray information is counted. For example, when “paper tray 1” is specified and the size is specified as A4, the number of times A4-size paper corresponding to “paper tray 1” has been specified is incremented. If specification concerning paper quality is made, information of the number of times the paper quality has been specified may also be counted for each paper tray.

That is, in the embodiment, the controller 11 stores the history of the number of times image data has been received for each port, the history of the number of times image data has been received for each description language type, the history of the number of times image data has been received for each paper size, the history of the number of times image data has been received for each mode of color and monochrome, the history of the number of times each paper tray has been determined, the history of the number of times the both-side mode (the image formation applied to both sides of a paper) has been specified, and the like in the storage portion 13 as the target data information concerning the image data to which image formation processing is applied.

The controller 11 rasterizes the received image data, generates bit map image data, and outputs the bit map image data to the printer portion 18. At this time, the controller 11 reserves the storage capacity required for retaining the bit map image data in the specified resolution and in the specified mode (color or monochrome, etc.,) in the memory 12. At this time, if the capacity to be reserved is insufficient, the controller 11 performs processing of waiting, etc., until any other data is deleted and the area is released, and also counts the number of times the storage capacity has become insufficient and records the count. The controller 11 also calculates the size representing the insufficient storage capacity (insufficient size) and records the statistical value. As the statistical value, for example, the maximum value or the average of the past insufficient sizes may be calculated and recorded.

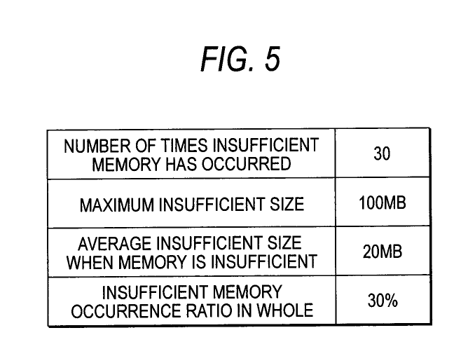

Further, the controller 11 may count and record the number of times image data has been rasterized (number of image formation times) and may divide the number of times the storage capacity has become insufficient by the number of image formation times to calculate the insufficient memory occurrence ratio and may record the insufficient memory occurrence ratio. The records (corresponding to the use amount of storage means in the invention) are stored in the storage portion 13, etc., (FIG. 5).

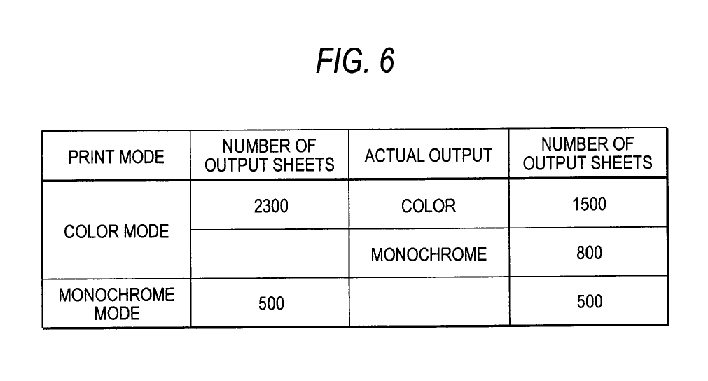

In addition, the controller 11 records information concerning the number of pixels of each formed image, error occurrence, etc., (processing information) in the progress of image formation processing. To form an image in a different mode from the default mode set in the printer portion 18 (color mode or monochrome mode), the controller 11 records the number of times the mode has been changed. The controller 11 also counts the number of specification times for each mode and the number of times image data using only the monochrome color material (black) has been input although the color mode was specified, and records the counts in the storage portion 13, etc., (FIG. 6).

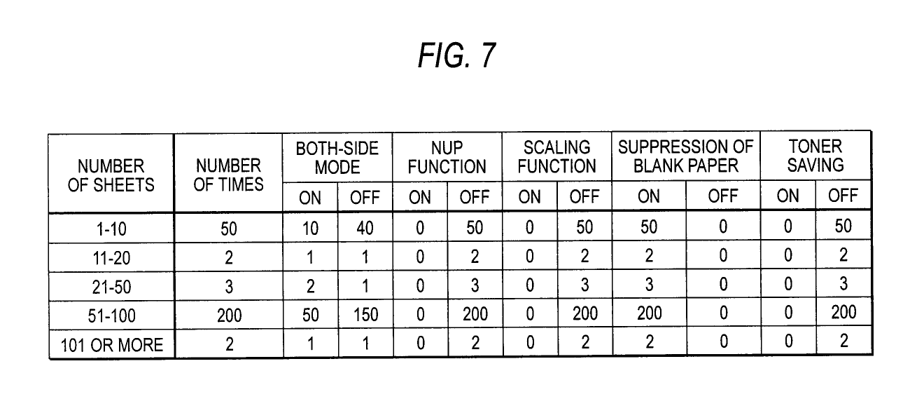

Further, the controller 11 records the number of times of ON or OFF of both-side mode, the number of times of ON or OFF of setting of collecting more than one page into one sheet of paper, the number of times of ON or OFF of scaling up/down, the number of times of ON or OFF of specification of ejection suppression of blank paper, the number of times of ON or OFF of toner saving specification, etc., as many times as specified for each page range contained in the image data relating to an image formation command (a range) in the storage portion 13, etc., (FIG. 7).

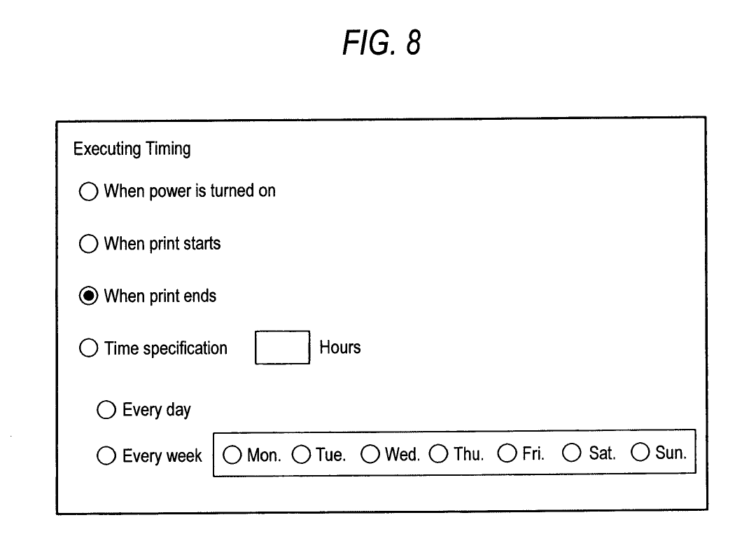

The controller 11 generates and presents the hint information concerning optimization in accordance with a proposition rule based on the recorded information at a timing (hint search timing). The hint search timing is previously selected from among (1) when power is turned on, (2) before image formation is started (namely, timing at which image data is received), (3) after image formation processing, and (4) specified time. To select the specified time, the execution start time every day or on the specified day of week is set additionally. Thus, the controller 11 presents an interface screen as shown in FIG. 8, accepts the setting, and stores it in the storage portion 13, etc.

When the specified timing is reached, the controller 11 reads the target data information and the processing information stored in the storage portion 13. The controller 11 selects the condition satisfied by the target data information or the processing information from among the conditions associated with the hint information belonging to the hint information group set so as to be presented.

For example, when hint information presentation is set for the memory hint information group and the condition that the number of times insufficient memory has occurred is “10 or more” is set, if the information of the number of times insufficient memory has occurred stored in the storage portion 13 is “30,” the hint information associated with the condition of the number of times insufficient memory has occurred is presented at the specified timing. To present the hint information, for example, the controller 11 displays the hint information on the display 15. In this case, for example, hint information to the effect that “addition of memory is recommended” is presented. Information of the maximum insufficient memory size, the average insufficient memory size, etc., may be presented together. Accordingly, a user can know a guideline for the memory capacity to be added.

Likewise, if hint information presentation is set for the hint information group concerning the mode of color or monochrome, etc., when the number of times the non-default mode has been set is larger than the number of times the default mode has been set for the number of times mode switching (switching from the color mode to the monochrome mode, etc.,) has occurred, hint information to the effect that “changing the default mode is recommended” may be presented.

The ratio of receiving monochrome image data with specification of image formation in the color mode is calculated and if the ratio exceeds the threshold value specified in the condition, hint information to the effect that “the monochrome mode can be specified for executing efficient image formation” may be presented.

For example, when the image data specified as the color mode is “2300” sheets and the actual color image data is “1500” sheets and the actual monochrome image data (using only the black color material) is “800” sheets, the ratio is 800/2300=34%. When the ratio is 30% or more, hint information to the effect that “the monochrome mode can be specified for executing efficient image formation” may be presented.

Further, if a port receiving image data less than a threshold number of times exists among the image data reception ports, hint information to the effect that processing for the port should be canceled may be presented. In this case, hint information to the effect that processing for the corresponding port should be canceled may be associated with the condition that the number of times each port has received image data is less than a threshold number of times in the proposition rule. Accordingly, a user cancels the processing involved in the port with a small number of reception occasions, whereby the storage capacity of the reception buffer relating to the port, the monitor processing burden on the controller 11, etc., can be lightened and the image formation efficiency is enhanced. Likewise, in processing relating to description language of image data, hint information to the effect that processing for the corresponding type of description language should be canceled may be associated with the condition that the number of times image data has been received for each type of description language is less than a threshold number of times.

If the number of pages involved in image formation is larger than a range, when the specification ratio of collecting both sides or a plurality of pages into one sheet of paper is smaller than a ratio threshold value, hint information to the effect that the number of used paper sheets can be decreased by making specification of collecting both sides or a plurality of pages into one sheet of paper may be presented. Further, for scaling up/down, suppression of blank paper, and toner saving, hint information to the effect that such a mode can be specified is stored in the storage portion 13 in association with a condition that the number of the times the mode has been selected is less than a ratio threshold value. Accordingly, it is made possible to provide a user with hint information about the modes not used by a user, and knowledge required for more efficient use can be presented to a user.

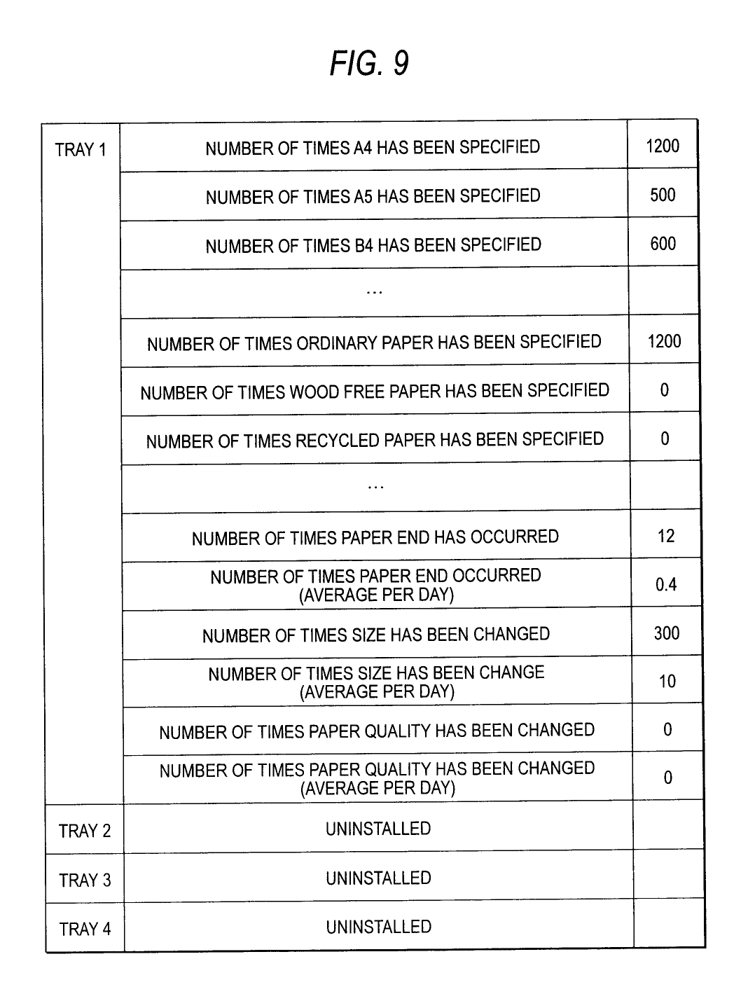

In the description made so far, the information relevant to the image data to which image formation processing is applied and information concerning the progress of image formation processing are recorded and conditions relating to the information are set as the hint information presentation rules. However, the embodiment is not limited to the mode. For example, for each tray of the printer portion 18, information of the number of times the size of paper stored in the paper tray has been changed (or change frequency per day) may be recorded. The condition relating to the number of change times and hint information for prompting a user to add a paper tray are associated with each other and are contained in a presentation rule for storage in the storage portion 13 (FIG. 9), whereby when the number of times the size of paper in the paper tray has been changed exceeds a threshold value, for example, the controller 11 may display a message for prompting a user to add a paper tray.

Further, in the description made so far, the hint information is presented as it is displayed, but the invention is not limited to the mode; the hint information may be transmitted to an electronic mail address. A setting change command may be associated instead of or together with the hint information and the setting may be changed in accordance with the setting change command associated with the hint information instead of or together with presenting the hint information to a user by the controller 11. For example, a command for changing setting of the default mode to the monochrome mode if the color print ratio is less than a ratio although the default mode is set to the color mode may be associated.

1. An image forming apparatus comprising:
a storage unit that holds target data information on image data to which image formation processing is applied and processing information on a process of the image formation processing;
a generating unit that generates hint information on optimization of the image forming apparatus in accordance with a presentation rule; and
a display that provides the hint information.

2. The image forming apparatus according to claim 1 wherein the target data information contains at least one of:
information on a port used for receiving the image data;
information on a description language used for describing the image data;
information on a recording medium size specified for image formation;
information indicating that the image data is one of a color mode and a monochrome mode;
information on determining a recording medium tray used in the image formation; and
information indicating whether the image formation is to be executed on both sides of a recording medium.

3. The image forming apparatus according to claim 1, further comprising a memory that operates as a work memory of image formation,
wherein the processing information contains at least one of:
a use amount of the memory at a time of the image formation;
the number of pixels of an image to be formed; and
information on error occurrence.

4. A method for forming an image in an image forming apparatus, comprising:
recording target data information on image data to which image formation processing is applied and processing information on a process of the image formation processing;
generating hint information on optimization of the image forming apparatus in accordance with a presentation rule; and
providing the hint information.

5. A computer readable medium storing a program causing a computer to execute a process for forming an image in an image forming apparatus, the process comprising:
recording target data information on image data to which image formation processing is applied and processing information on a process of the image formation processing;
generating hint information on optimization of the image forming apparatus in accordance with a presentation rule; and
providing the hint information.

6. A computer data signal embodied in a carrier wave for enabling a computer to perform a process for forming an image in an image forming apparatus, the process comprising:
recording target data information on image data to which image formation processing is applied and processing information on a process of the image formation processing;
generating hint information on optimization of the image forming apparatus in accordance with a presentation rule; and
providing the hint information.
